(19) United States
(12) Patent Application Publication
(10) Pub. No.: US 2017/0155837 A1
(43) Pub. Date: Jun. 1, 2017

(54) SYSTEM AND A METHOD FOR MANIPULATING A VIDEO FILE ON RECEIVING INSTRUCTIONS FROM A USER

(71) Applicant: DAVID BORISH, NEW YORK, NY (US)

(72) Inventor: DAVID BORISH, NEW YORK, NY (US)

(73) Assignee: NEO, LLC, New York, NY (US)

(21) Appl. No.: 15/349,409

(22) Filed: Nov. 11, 2016

Related U.S. Application Data
(60) Provisional application No. 62/260,376, filed on Nov. 27, 2015.

(51) Int. Cl. H04N 5/232; H04N 21/4402; H04N 21/433; H04N 5/262; G11B 27/36; H04N 5/92; H04N 9/804; H04N 9/79; H04N 21/4223; G11B 31/00

(52) U.S. Cl. CPC H04N 5/23238; H04N 21/4223; H04N 21/4402; H04N 21/4334; G11B 31/00; G11B 27/36; H04N 5/92; H04N 9/8042; G11B 31/006; H04N 9/7925; H04N 5/2628; H04N 5/2624

(57) ABSTRACT

Disclosed is a system communicating with a communication network for manipulating a received file. The system includes a central processor, a display unit coupled to the processor, a central memory unit coupled to the central processor to store the video file. The central processor is operable to convert the video file to a sequence of frames, followed by separation of the sequence of frames into individual frames, further followed by encoding each frame to allow user control for creating a package of frames. The central processor is further processed to display the video file through the display unit on decoding the package of frames, followed by displaying the individual frames of the video file through the display unit on receiving a tap of the user, and lastly followed by manipulating the individual frames to view in all directions of the video file on receiving instructions from the user.

### CROSS-REFERENCE TO RELATED APPLICATION

The present invention claims priority benefit of U.S. Provisional Patent Application No. 62/260,376 filed on Nov. 27, 2015, which is incorporated herein by reference.

### BACKGROUND OF THE INVENTION

1. Field of the Invention

The present invention generally relates to a system and a method for playing a high-speed video and more particularly relates to a system and a method for manipulating the video file on receiving instructions from a user, the video file recorded by a camera capable of recording in a high frame rate.

2. Description of Related Art

Virtual reality technology is becoming more common, and several methods for capturing and providing virtual reality images to users already exist. In general, the term “virtual reality” refers to a computer simulation of a real or imaginary environment or system that enables a user to perform operations on the simulated system, and shows the effects in real time.

A popular method for capturing images of a real environment to create a virtual reality experience involves capturing a 360 degree video file of the surroundings, using multiple cameras at varying angles, and then stitching the multiple camera angles together to make one cohesive 360 degree video file. Thereafter the video is incorporated into a computer model to produce a simulation. Thus, allowing a user to view in all directions.

Further, existing systems are known to manipulate a video file, however, these systems are recorded in the same device and further requires the video to be as a series of individual frames at a selected frame rate, e.g. 24 frames per second (fps), and each frame is captured by accumulating light for a selected exposure time within the available frame time, e.g. 41.7 millisec (= 1/24 sec.). Each frame is a two-dimensional array of individual pixels.

Therefore, there is a need of a system that is able to manipulate a received video file on receiving instructions from a user. Further, the system should be able to communicate with a communication network. Further, the system should allow the user to manipulate each frame of the video file.

### SUMMARY OF THE INVENTION

In accordance with teachings of the present invention, a system for manipulating a received video file on receiving instructions from a user is provided.

An object of the present invention is to provide a system communicating with a communication network for manipulating a received file. The system includes a central processor, a display unit coupled to the processor, a central memory unit coupled to the central processor to store the video file. The central processor is operable to convert the video file to a sequence of frames, followed by separation of the sequence of frames into individual frames, further followed by encoding each frame to allow user control for creating a package of frames.

The central processor is further processed to display the video file through the display unit on decoding the package of frames, followed by displaying the individual frames of the video file through the display unit on receiving a tap of the user, and lastly followed by manipulating the individual frames to view in all directions of the video file on receiving instructions from the user.

Another object of the present invention is to provide the system wherein the central processor is further configured to add Meta data to the frames on receiving instructions from the user. Further, the central processor is further configured to export at least a section of the package of frames using tools to specific output formats.

Another object of the present invention is to provide the system with one or more high-speed cameras to record video file. Further, the central processor is configured to upload the recorded video file to the memory unit. Further, the central processor is configured to share the video file through the communication network, and to compress and optimize the package of frames to transfer through the communication network.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a block diagram of a system for manipulating a received video file on receiving instructions from a user;

FIG. 2 illustrates a screenshot showing of a system for either displaying a first mode of standard high-speed video or a second mode of 360 degree high-speed video or a third mode 360 degree in virtual reality (VR) mode;

FIG. 3 illustrates a screenshot showing of a first mode for manipulating a standard high-speed video in accordance with a preferred embodiment of the present invention; and

FIG. 4 illustrates a screenshot showing of a second mode for manipulating a high-speed video in 360 degree mode in accordance with another preferred embodiment of the present invention; and

FIG. 5 illustrates a screenshot showing of a third mode for manipulating a high-speed video in 360 degree virtual reality (VR) mode in accordance with another preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, a system for manipulating a received video file on receiving instructions from a user may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

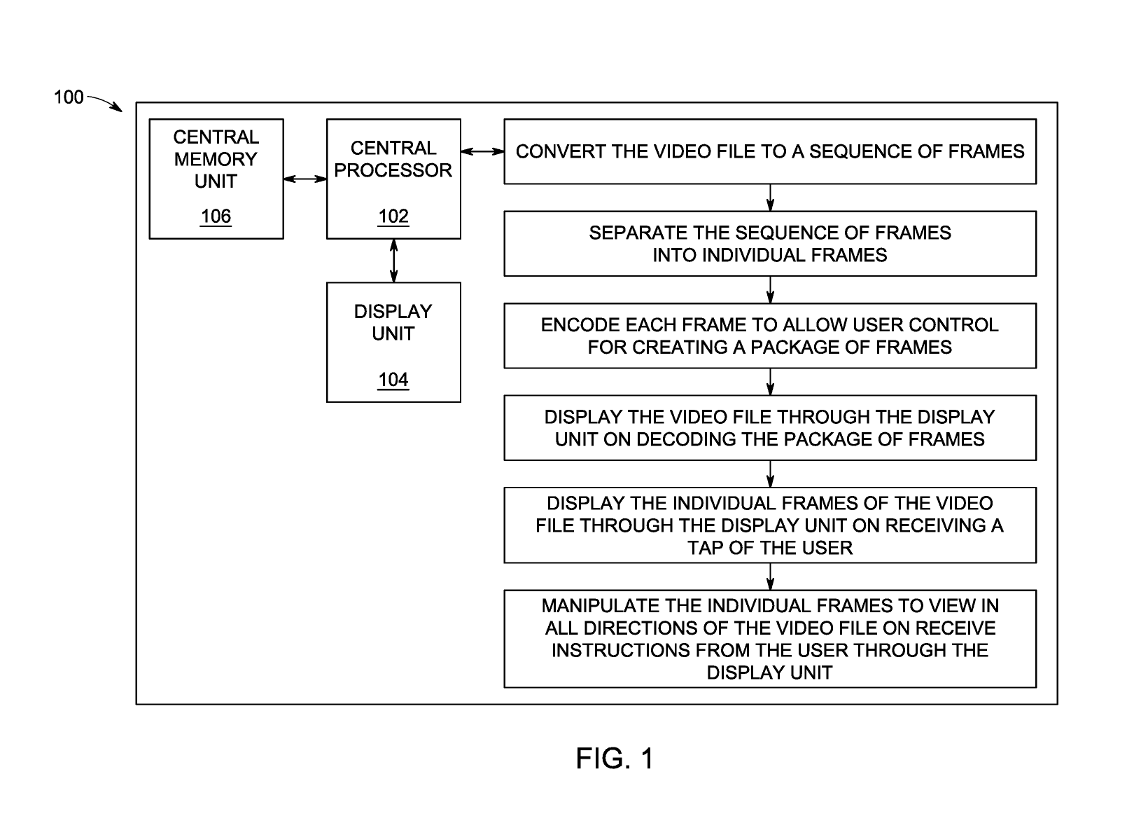

FIG. 1 illustrates a block diagram of a system 100 for manipulating a received video file on receiving instructions from a user. The system 100 communicates with a communication network. The system 100 includes a central processor 102, a display unit 104 coupled to the central processor 102, and a central memory unit 106 coupled to the central processor 102 to store the video file.

The central processor 102 is operable to convert the video file to a sequence of frames, followed by separation of the sequence of frames into individual frames. The central processor 102 further encodes each frame to allow user control for creating a package of frames. The central processor 102 further displays the video file through the display unit 104 on decoding the package of frames.

The central processor 102 further displays the individual frames of the video file through the display unit 104 on receiving tap of the user. The central processor 102 further manipulates the individual frames to view in all directions of the video file on receiving instructions from the user through the display unit 104.

For exemplary purposes, a standard high-speed video file is played back in one continuous frame. The present invention separates the video file into individual frames based on the amount of frames/second of the recorded video file. Further, the present invention allows the user to play the video file in any amount of frames/second.

In another preferred embodiment of the present invention, the central processor 102 is further configured to add Meta data to any frame of the high speed video file. In a preferred embodiment of the present invention, the meta data may be pre-stored in the central memory unit 106.

Further in another preferred embodiment of the present invention, the meta data may be added to any frame either during the encoding or after encoding of the video file. Examples of the meta data include but not limited to text, video, visual, audio, or in combination.

In another preferred embodiment of the present invention, the central processor is further configured to export at least a section of the package of frames using tools to specific output frames through the communication network. In a preferred embodiment of the present invention, the central processor 102 is able to send the section of the package of the frames to a central server using the communication network. Thus, the central processor of other users system downloads the package of frames from the central server.

In another preferred embodiment of the present invention, the system 100 further includes a high speed camera to record video file. Examples of high speed camera include but not limited to a camera recording at or more than 80 frames/second. It would be readily apparent to those skilled in the art that various high-speed cameras may be used without deviating from the scope of the present invention.

In another preferred embodiment of the present invention, the central processor 102 is further configured to upload the video file recorded by the high-speed camera to the memory unit or the central server. Further, the central processor 102 is able to share the video file through the communication network.

Further in another preferred embodiment of the present invention, the high speed camera is able to record a 360 degree video file. The central processor 102 is further able to compress and optimize the package of frames to transfer through the communication network.

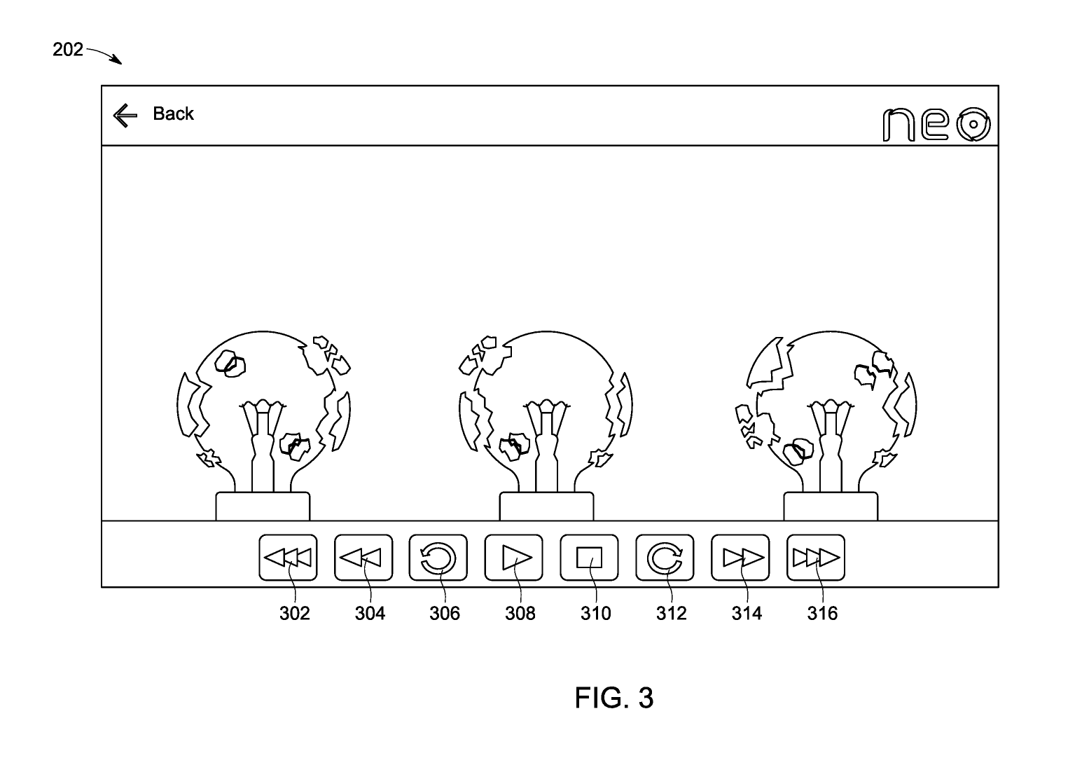

In another preferred embodiment of the present invention, the central processor 102 is further configured to manipulate the speed of video file ranging from the maximum amount of frames/second recorded to each frame separately. The central processor 102 further manipulates the speed of recorded 360 degree video file. The manipulation of the speed of the video is explained in detail in conjunction with FIG. 3 of the present invention.

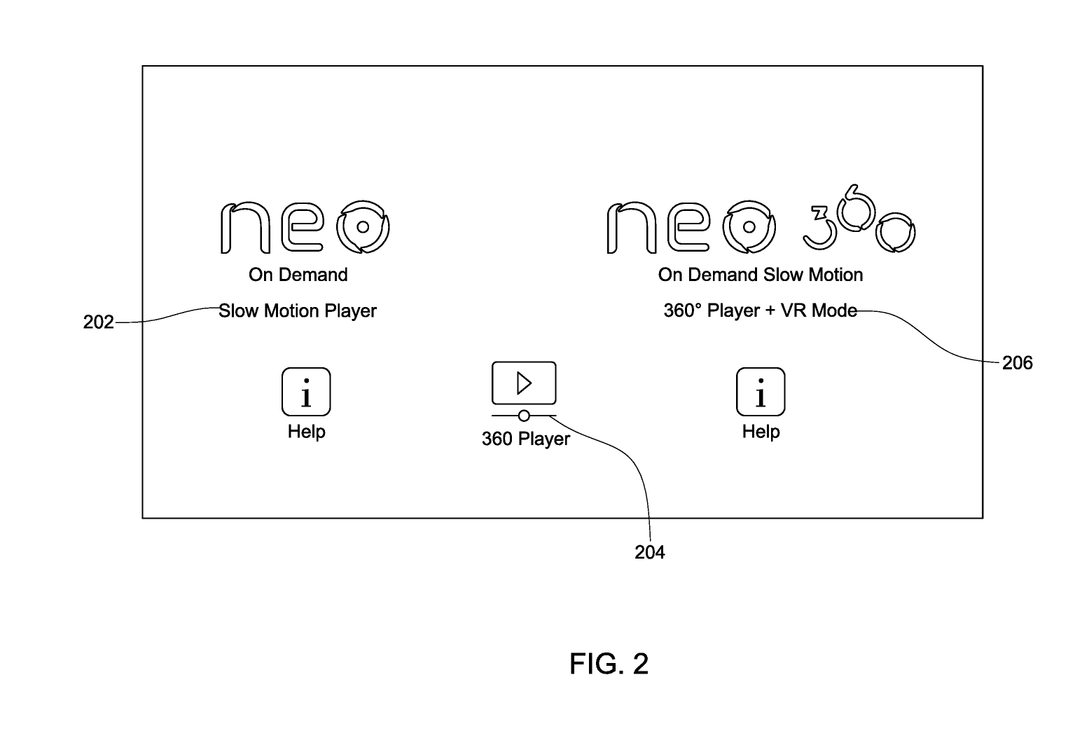

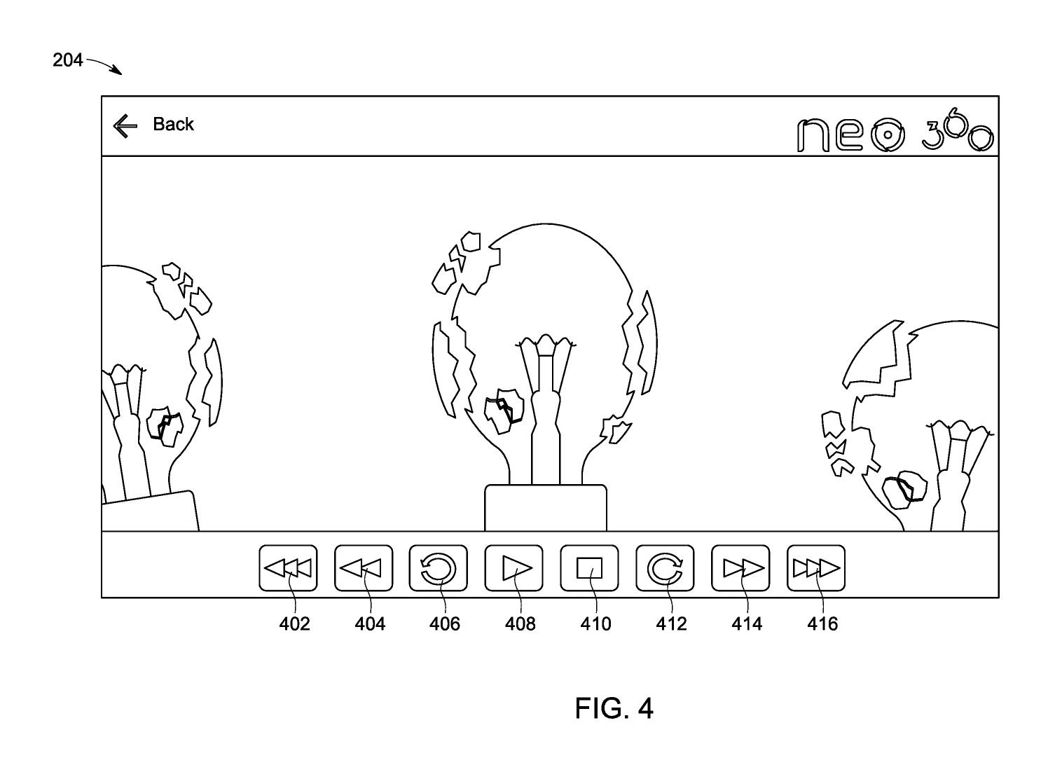

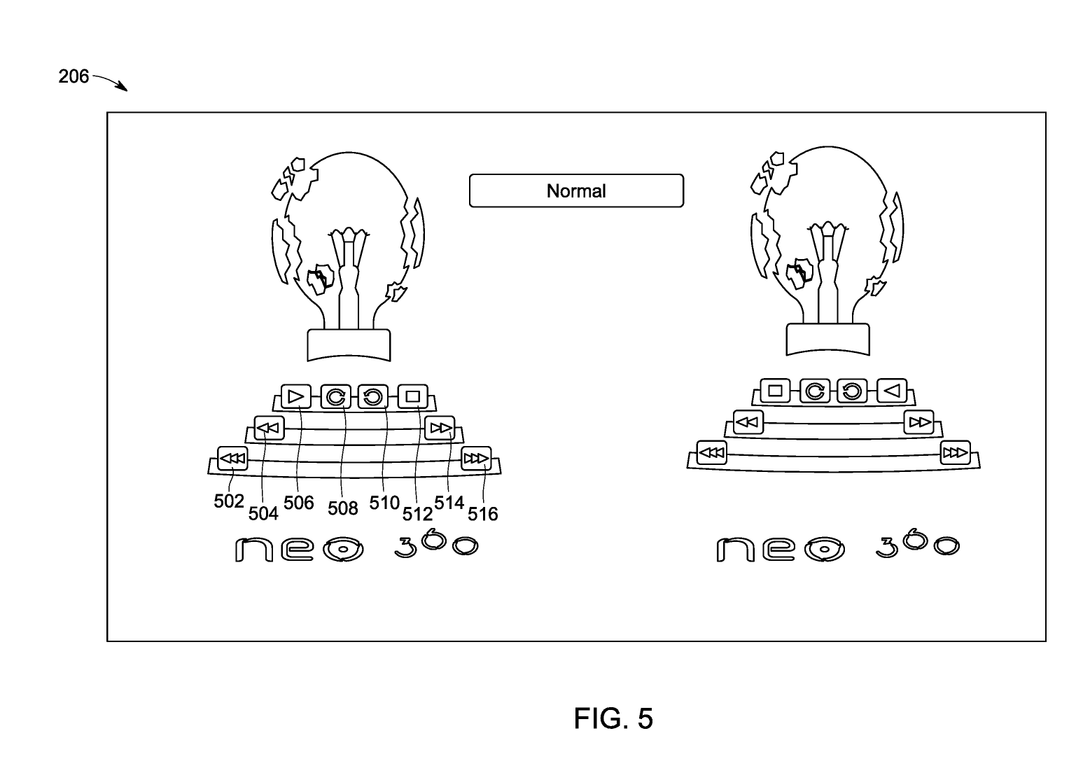

FIG. 2 illustrates a screenshot showing of a system for either displaying a first mode 202 of standard high-speed video file or a second mode 204 of 360 degree video or a third mode 206 360 degree video file in virtual reality mode. The user is able to select either the first mode 202 or the second mode 204 or the third mode 206 to play the recorded video file. The first mode 202, the second mode 204 and the third mode 206 is explained in detail in conjunction with FIG. 3, FIG. 4 and FIG. 5, respectively of the present invention.

FIG. 3 illustrates a screenshot showing of the first mode 202 for manipulating a standard high-speed video. The first mode 202 plays a standard high speed video file. The first mode 202 provides control buttons to receive a tap from the user to manipulate the video file. The first button 302 is to slow the high-speed video down to the slowest number of frames per second.

The second button 304 is to slow the high-speed video down to the second slowest number of frames per second. The third button 306 is to reverse the sequence of frames in any previously viewed frames per second. The fourth button 308 is to play the sequence of frames in standard 24 frames per second.

The fifth button 310 is to stop the sequence of frames from playing. The sixth button 312 is to forward the sequence of frames in any previously viewed frames per second. The seventh button 314 is to speed up the high-speed video to the second fastest number of frames possible per second. The eighth button 316 is to speed up the high-speed video to the fastest number of frames possible per second.

FIG. 4 illustrates a screenshot showing of the second mode 204 for manipulating a high-speed video in 360 degree mode in all possible directions. The second mode 204 plays the high-speed video file in multiple speeds in 360 degrees. The second mode 204 provides control buttons to receive a tap from the user to manipulate the video file.

The first button 402 is to slow the high-speed video down to the slowest number of frames per second. The second button 404 is to slow the high-speed video down to the second slowest number of frames per second. The third button 406 is to reverse the sequence of frames in any previously viewed frames per second.

The fourth button 408 is to play the sequence of frames in standard 24 frames per second. The fifth button 410 is to stop the sequence of frames from playing. The sixth button 412 is to forward the sequence of frames in any previously viewed frames per second.

FIG. 5 illustrates a screenshot showing of the third mode 206 for manipulating a high-speed video in all possible directions in 360 degree virtual reality mode. The third mode 206 plays the high-speed video file in multiple speeds in 360 degree. The third mode 206 provides control buttons to receive a tap from the user to manipulate the video file.

The first button 502 is to slow the high-speed video down to the slowest number of frames per second. The second button 504 is to slow the high-speed video down to the second slowest number of frames per second. The third button 506 is to reverse the sequence of frames in any previously viewed frames per second.

The fourth button 508 is to play the sequence of frames in standard 24 frames per second. The fifth button 510 is to stop the sequence of frames from playing. The sixth button 512 is to forward the sequence of frames in any previously viewed frames per second.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for manipulating a received video file on receiving instructions from a user, the system communicates with a communication network, the system comprising:
a central processor;
a display unit coupled to the central processor; and
a central memory unit coupled to the central processor to store the video file, wherein the central processor operable to:
convert the video file to a sequence of frames;
separate the sequence of frames into individual frames;
encode each frame to allow user control for creating a package of frames;
display the video file through the display unit on decoding the package of frames;
display the individual frames of the video file through the display unit on receiving a tap of the user; and
manipulate the individual frames to view in all directions of the video file on receive instructions from the user through the display unit.

2. The system according to claim 1, wherein the central processor further configured to add meta data to any frame of the high speed video file.

3. The system according to claim 1, wherein the central processor is further configured to export at least a section of the package of frames using tools to specific output formats through the communication network.

4. The system according to claim 1 further comprising one or more high speed cameras to record video file.

5. The system according to claim 4 wherein the central processor is further configured to upload the recorded video file to the memory unit.

6. The system according to claim 1, wherein the central processor is further operable to share the video file through the communication network.

7. The system according to claim 1, wherein the central processor is further configured to compress and optimize the package of frames to transfer through the communication network.

8. The system according to claim 1 wherein the central processor is further configured to manipulate the speed of video ranging from the maximum amount of frames/second recorded to each frame separately.

9. The system according to claim 4, wherein the high speed camera records a 360 degree video file.

10. The system according to claim 9, wherein the central processor is further configured to manipulate the direction of the recorded 360 degree video file.

11. The system according to claim 1 wherein the recorded video file is 360 degree video file, further wherein the central processor is configured to manipulate the direction of the recorded 360 degree video file.
